(19) United States
(12) Patent Application Publication
(10) Pub. No.: US 2009/0187298 A1
(43) Pub. Date: Jul. 23, 2009

(54) VEHICLE PROPULSION ARRANGEMENT

(76) Inventors: Robert D. Cuppetilli, Canton, MI (US); Antonio Francisco Cesaroni, Padova (IT)

Correspondence Address: CARLSON, GASKEY & OLDS, P.C., 400 WEST MAPLE ROAD, SUITE 350, BIRMINGHAM, MI, 48009, US

(21) Appl. No.: 12/178,803

(22) Filed: Jul. 24, 2008

Related U.S. Application Data
(60) Provisional application No. 61/021,917, filed on Jan. 18, 2008.
(60) Provisional application No. 61/056,879, filed on May 29, 2008.
(60) Provisional application No. 61/075,783, filed on Jun. 26, 2008.

(51) Int. Cl. B60L 11/18; F16H 3/72

(52) U.S. Cl. 701/22; 475/5

(57) ABSTRACT

An example vehicle propulsion arrangement includes a planetary gear differential. A first branch of the planetary gear differential is rotatably connected to a first source of rotation. A second branch of the planetary gear differential is rotatably connected to a second source of rotation. A third branch of the planetary gear differential is rotatably connected to a vehicle drive axle. The first branch, the second branch, or both, rotate the third branch of the planetary gear system to rotate the vehicle drive axle.

### CROSS-REFERENCE TO RELATED APPLICATIONS

This application claims priority to U.S. Provisional Application No. 61/021,917, which was filed on 18 Jan. 2008; U.S. Provisional Application No. 61/056,879, which was filed on 29 May 2008; and U.S. Provisional Application No. 61/075783, which was filed on 26 Jun. 2008, all of which are incorporated herein by reference.

### BACKGROUND

This disclosure relates to an arrangement for propelling a vehicle. More particularly, this disclosure relates to propelling a vehicle using power supplied by an engine, a rechargeable energy source, or both.

As known, turning a vehicle drive axle propels many types of vehicles. Some vehicles turn the vehicle drive axle relying solely on power supplied by an engine, such as an internal combustion engine. These vehicle types are often adequately powered, but the engine disadvantageously requires frequent and continual refuelling due in part to inefficiencies inherent in the engine.

Other vehicle types turn the vehicle drive axle using an electric motor powered by a rechargeable energy storage device, such as a rechargeable battery. Many consumers desire more power from these electric-based vehicles. Further, the energy storage device is bulky, requires recharging, and is costly. Some of these electric-based vehicles, such as a hybrid synergy drive vehicles, use the electric motor in combination with a continuously variable transmission. Such vehicles often incorporate drive-by-wire technologies. That is, there is no direct mechanical connection between an accelerator pedal and the electric motor controls.

### SUMMARY

An example vehicle propulsion arrangement includes a planetary gear differential. A first branch of the planetary gear differential is rotatably connected to a first source of rotation. A second branch of the planetary gear differential is rotatably connected to a second source of rotation. A third branch of the planetary gear differential is rotatably connected to a vehicle drive axle. The first branch, the second branch, or both, rotate the third branch of the planetary gear system to rotate the vehicle drive axle.

An example system for propelling a vehicle includes a planetary gear arrangement. A hydraulic drive assembly is operative to rotatably drive a first shaft of the planetary gear arrangement. An engine powers the hydraulic drive assembly and includes an engine shaft operative to rotatably drive the hydraulic drive assembly. The input shaft is rotatable at a different speed than the first shaft. An electric motor is operative to rotatably drive a second shaft of the planetary gear arrangement, and a rechargeable battery powers the electric motor. A third shaft of the planetary gear arrangement is operative to rotatably drive a vehicle drive axle.

An example method of propelling a vehicle includes the steps of powering a hydraulic drive assembly with an engine shaft rotating at a first speed and rotating a first shaft at a second speed with the hydraulic drive assembly. The first shaft is rotatably connected to a planetary gear arrangement. The method includes rotating a second shaft with an electric motor. The first second shaft is rotatably connected to a planetary gear arrangement. The method also includes rotating a third shaft to rotate a vehicle drive axle using the first shaft, the second shaft, or both.

These and other features of the example disclosure can be best understood from the following specification and drawings, the following of which is a brief description:

### BRIEF DESCRIPTION OF THE DRAWINGS

FIG. 1 illustrates a schematic view of an example vehicle propulsion arrangement.

FIG. 2 illustrates a detailed view of the FIG. 1 arrangement.

### DETAILED DESCRIPTION

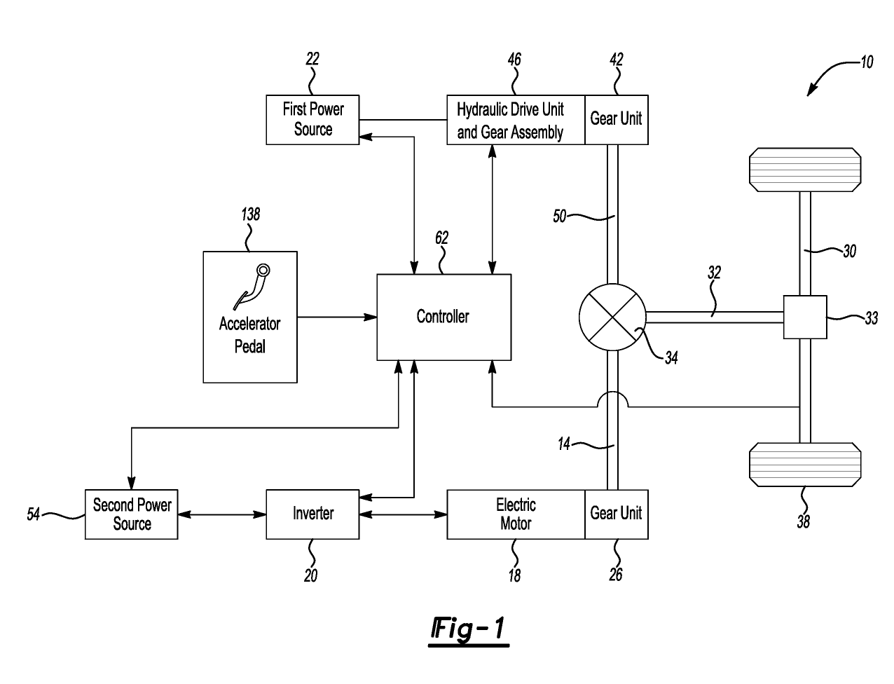

Referring to FIG. 1, an example vehicle propulsion arrangement 10 includes a three-branch planetary gear differential 34. A first shaft 50, a second shaft 14, and a third shaft 32 rotatably connect to the planetary gear differential 34. The first shaft 50, the second shaft 14, and the third shaft 32 represent the three branches of the planetary gear differential 34 in this example.

A first power source 22, an engine in this example, powers a hydraulic drive unit and gear assembly 46 to rotatably drive the first shaft 50 though a gear unit 42, which provides a first source of rotation. A second power source 54 powers the electric motor 18, a type of reversible machine, to rotatably drive the second shaft 14 through a gear unit 26, which provides a second source of rotation. The first power source 22 powers a generator 58 to recharge the second power source 54, in this example.

The first shaft 50, the second shaft 14, or both, rotate the third shaft 32 through the planetary gear differential 34. The rotational direction and speed of the third shaft 32 depends on the rotational direction and speed of the first shaft 50 and the second shaft 14. The speed can be adjusted by the changing the internal gear ratio of the planetary gear differential 34. Rotating the third shaft 32 rotates the vehicle drive axle 30 through a differential gear assembly 33, and rotating the vehicle drive axle 30 rotates at least one vehicle wheel 38. As known, turning the at least one wheel 38 moves a vehicle.

A controller 62 is mounted in communication with the hydraulic drive unit and gear assembly 46, the first power source 22, and other portions of the example vehicle propulsion arrangement 10. The controller 62 receives input information from an accelerator pedal 138 and the rotation speed of the vehicle drive axle 30 in this example. As known, a vehicle operator repositions the pedal 138 to indicate a desired vehicle speed. In this example, the position of the accelerator pedal 138 is communicated to the controller 62, which adjusts the speed of the first shaft 50 to increase or decrease the speed of the vehicle by speeding or slowing the rotational speed of the third shaft 32.

In this example, the hydraulic drive unit and gear assembly 46 and the gear unit 42 are arranged in a series-type relationship relative to the first power source 22 and the first shaft 50. That is, the first power source 22 does not bypass the hydraulic drive unit and gear assembly 46 to drive the gear unit 42. In another example, the hydraulic drive unit and gear assembly 46 and the gear unit 42 are arranged in a parallel-type relationship. That is, the first power source 22 engages gearing enabling the first power source 22 to directly drive both the gear unit 42 and the hydraulic drive unit and gear assembly 46.

The planetary gear differential 34 is configured such that the amount of torque and the rotational direction of the first shaft 50 depends on the amount of torque and the rotational direction of the third shaft 32 and the second shaft 14. The gear ratio of the planetary gear differential 34 controls the proportional differences between the torque of the first shaft 50 and torque of the third shaft 32. The planetary gear differential 34 is further configured such that the amount of torque and the rotational direction of the second shaft 14 depends on the amount of torque and the rotational direction of the third shaft 32 and the first shaft 50. The gear ratio of planetary gear differential 34 establishes the proportional differences between the torque of the second shaft 14 and the torque of the third shaft 32. Thus, when driven, the rotational speed and rotational direction of one of the first shaft 50, the second shaft 14, and the third shaft 32 depends on the rotational speed and rotational direction of the others of the first shaft 50, the second shaft 14, and the third shaft 32. The amount of torque on the first shaft 50 and the second shaft 14 can differ.

In this example, when the rotational direction and torque of the second shaft 14 have the same direction, the electric motor 18 is powering the planetary gear differential 34. When rotational direction and torque of the second shaft 14 have opposite directions, the power moves from the planetary gear differential 34 to the electric motor 18. The second shaft 14 is powered by the first power source 22 through the first shaft 50 and the slowing vehicle drive axle 30.

In the example vehicle propulsion arrangement 10, the second power source 54 is a rechargeable power source, such as a battery. An inverter 20 is in communication with the electric motor 18 and the second power source 54. When the electric motor 18 is not driving the second shaft 14, rotating the second shaft 14 recharges the second power source 54 through the inverter 20. The controller 62 controls rotational speed and rotational direction of the electric motor 18 through the inverter 20. The example controller 62 is also operative to control the hydraulic drive unit and gear assembly 46 gear ratio by setting the hydraulic pump displacement and the engine. The example controller 62 is also operative to controller the torque and speed of the first power source 22 or some combination thereof.

In this example, the gear unit 42, the gear unit 26, the engine, first power source 22, the hydraulic drive unit and gear assembly 46, the electric motor 18, the first shaft 50, the second shaft 14, the planetary gear differential 34, the third shaft 32 and the vehicle drive axle 30 are continuously engaged. Although the first shaft 50 is lockable against rotation, the example vehicle propulsion arrangement 10 does not rely on shifting or disengaging gears.

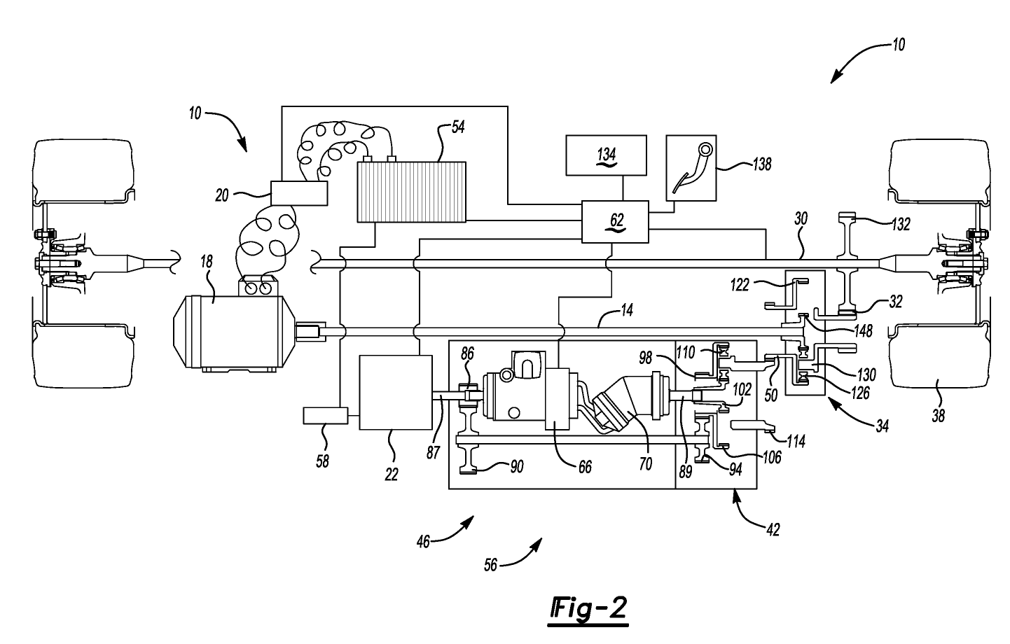

Referring now to the FIG. 2 example with continuing reference to the FIG. 1, the example electric motor 18 is an AC electric motor connected to a battery 54, a type of second power source 54, through the inverter 20. Other example reversible machines include a DC motor, an air compressor, a hydraulic pump, or a hydraulic motor. As known, these examples are configurable to rely on a rechargeable power source, e.g., compressed air, and can recharge the battery 54 utilizing the rotation of the first shaft 14.

The example hydraulic drive unit and gear assembly 46 includes a variable displacement axial piston hydraulic pump 66 in communication with an axial piston hydraulic motor 70. A engine shaft 87 extends from the engine 22 to rotatably drive the hydraulic pump 66. In this example, the engine 22 is a gasoline internal combustion engine. Other examples utilize a turbine engine or a diesel engine or other technologies.

A hydraulic motor shaft 89 extends from hydraulic pump 66 to rotatably drive the gear unit 42. Notably, as is known, the hydraulic motor shaft 89 is rotatable at a different speed than the engine shaft 87 depending on the configuration of the hydraulic drive unit and gear assembly 46. The controller 62 is configured to adjust the hydraulic drive unit and gear assembly 46 to change the relative rotational speeds between the hydraulic motor shaft 89 and the engine shaft 87

In this example, the hydraulic drive unit and gear assembly 46 and the gear unit 42 provide a continuous gear ratio variable transmission (CGRVT) 56, which communicates rotational input from the engine shaft 87 to the planetary gear differential 34 through the first shaft 50. The gear unit 42 comprises gears 94, 98; the planetary gear set 102, 106, 110; and the planetary carrier with a gear 114. In this example, the CGRVT 56 has a eight gear reduction between the engine 22 and the first shaft 50 of the planetary gear differential 34. Other examples include other gear reductions.

In this example, the hydraulic motor shaft 89 also engages a gear 86 to drive a gear and shaft 90 that directly rotates the gear unit 42. Thus, in this example, the gear unit 42 receives rotational input from the hydraulic motor shaft 89 and, in parallel, from the gear 90. Thus, the example CGRVT 56 provides a closed power ring since the gear unit 42 is arranged in a parallel configuration relative to the hydraulic drive unit and gear assembly 46. The rotation passes through two parallel branches from the engine 22 to the first shaft 50 of the planetary gear differential 34. Other examples include a CGRVT 56 having a linear rotation path, and multiple branches arranged in multiple parallel configuration. Still other examples of the CGRVT 56 include electric and mechanical arrangements. These examples are configured to vary the gear ratio continually. The example CGRVT 56 is configured such that in at least one operating condition, the first shaft 50 is locked against rotation while the engine shaft 87 continues to rotate.

The example planetary gear differential 34 includes gears 118, 122, 126, and a planetary carrier 130. Gear 118 is connected to the second shaft 14, gear 122 is connected with the first shaft 50, and planetary carrier 130 is connected with the third shaft 32. The planetary gear differential 34 can be any type gear assembly, such as epicycle or conic gears, and have various gear ratios. In this example, each of the branches 50, 14 and 32 transfers rotational power to and from the planetary gear differential 34.

The controller 62 in the FIG. 2 example includes software 134 operative to receive input information from the position of the accelerator pedal 138, the battery 54 charge and the vehicle drive axle 30 speed. The controller 62 controls the engine 22 speed and torque; the electric motor 18 speed, torque, and rotation direction through the inverter 20; and sets the hydraulic pump 66 displacement to alter the gear ratio of the CGRVT 56. The accelerator pedal 138 communicates with the controller 62 using electric signals. Other examples include hydraulic or mechanical signals. A person skilled in the art and having the benefit of this disclosure would understand how to design the controller 62 and the software 134 for communicating with the arrangement to achieve a desired performance of the vehicle, such as minimizing fuel consumption.

In this example, the vehicle drive axle 30 includes at least a gear 132 and a wheel 38. Other components include wheel bearings, suspensions, dumpers, axle differential, wheel hub, steering device, etc.

To maximize vehicle acceleration, the example configuration of the planetary gear arrangement 34 powers the vehicle drive axle 30 through the third shaft 32 using both the first power source 22 and the second power source 54 in parallel.

In this FIG. 2 example, the generator 58 assists with charging the battery 54. The example battery 54 provides electric power for a certain amount of time depending on desired operating conditions. In this example, the battery 54 has a capacity of 4000 kJ, which is the energy necessary to provide the vehicle with a full acceleration when the engine 22 is not powering the vehicle drive axle 30. The size of the battery 54 and the electric motor 18 can change depending on the desired power and weight for the vehicle.

The controller 62, in one example, is configured to turn the engine 22 off when the rotational speed of the first shaft 50 is zero. In this operating condition, the engine shaft 87 can rotate at any speed, but the first shaft 50 is locked against rotation. Thus, even though the engine 22 is turned off there is little or no dynamic performance variation in the vehicle.

In one example, the software 134, through the controller 62, turns the engine 22 on when the charge level of the battery 54 is low. When the battery 54 reaches an acceptable higher charge level, the software 134, through the controller 62, sets the CGRVT 56 gear ratio in a such way that the first shaft 50 speed is reduced to zero, which lowers the corresponding power delivered from the engine 22 to zero. The engine 22 can then be switched off without affecting the operating dynamics of the vehicle. The example engine 22 switches off to conserve fuel consumption when there is no power delivery through the CGRVT 56. In such a situation the second input shaft 50 is locked against rotation, even if all the parts are engaged. The engine 22 switches off regardless the rotational speed of the vehicle drive axle 30, i.e., it is not necessary to stop the vehicle to switch on or off the engine 22. The operating on or off condition of the engine 22 can be also governed manually by an operator while the vehicle is running.

In some examples the software 134, through the controller 62, turns the engine 22 off, but other examples are designed to keep the engine 22 running while the vehicle operates. These variations are possible in part because the rotation of the engine shaft 87 can be absorbed by the CGVRT 56 such that the rotation of the engine shaft 87 does not impact the vehicle operating dynamics.

To guard against frequently switching the engine 22 on or off, the signal to the controller 62 of a high charge of the battery 54 is significantly higher than the signal of low charge of the battery 54. In this example, every time the engine 22 is off, the rotational input provided by the CGRVT 56 to the first input shaft 50 is zero. Thus, a signal to the controller 62 indicating a low charge on the battery 54 is enough to turn the engine 22 on. To turn the engine 22 off, the controller 62 receives a signal indicating a high charge on the battery 54, and that the rotational input provided by the CGRVT 56 to the first input shaft 50 is zero. That is, the software 134 must wait until the rotational input provided by the CGRVT 56 to the input shaft 50 is zero before turning off the engine 22. This avoids damaging the engine 22 or any component of the complete system by turning off the engine 22 while the CGRVT 56 is still providing a rotation to the first input shaft 50.

During deceleration of the vehicle drive axle 30, the software 134 sets the hydraulic pump 66 displacement such that the first input shaft 50 does not rotate. Thus, during deceleration, power moving from the vehicle drive axle 30 though the third shaft 32 to the planetary gear differential 34 moves primarily through the second shaft 14 to recharge the battery 54 through the electric motor 18.

In this example, while the vehicle drive axle 30 maintains a relatively consistent rotational speed, the software 134 sets the hydraulic pump 66 displacement such that the engine 22 powers the vehicle drive axle 30, and rotates the second shaft 14 to recharge the battery 54. Since in such an operating condition the second shaft 14 rotation is opposite the direction of the torque, the power moves from the planetary gear differential 34 to the electric motor 18 through the second shaft 14 to recharge the battery 54.

Features of the example vehicle propulsion arrangement 10 include improved efficiency over previous arrangements and the continuously variable gear ratio portion that does not include disengaging parts or gears. The engine 22 can also be switched off when the vehicle speed is not zero, which saves fuel costs. When the vehicle slows, the power is routed primarily through the second shaft 14, rather than both the second shaft 14 and the first shaft 50. Such a routing facilitates a high regenerating capacity to this system and at the same time a very good regenerative braking to recharge the battery 54. When the vehicle moves at a relatively consistent speed, the engine 22 recharges the battery 54. There is also no operating condition when the vehicle or part of it can run in an idle gear arrangement.

Exemplary operating characteristics of the vehicle propulsion arrangement 10 including the following:

At a vehicle speed 12 km/h, the software 134 sets the torque of the electric motor 18 at 214.8 Nm, the speed of the electric motor 18 at −762 rpm, the speed of the engine 22 at 4250 rpm, the power delivery of the engine 22 at 40 kW, and the displacement of the hydraulic pump 66 at −14.75 cc. The performance of the vehicle under these settings is 0.39 g acceleration, and the battery 54 is recharged with 17.1 kW. In this example, at 12 km/h, the electric motor 18 rotates in the opposite torque direction, which, in this example, is the reverse direction from when the electric motor 18 rotates, or applies torque to, the second shaft 14. The electric motor 18 also charges the battery 54 using regenerative braking.

In another example, at vehicle speed 24 km/h, the software 134 sets torque of the electric motor 18 at 214.8 Nm, the motor speed at 254 rpm, the speed of the engine 22 at 4250 rpm, the power delivery of the engine 22 at 40 kW and the displacement of the hydraulic pump 66 at −14.74 cc. The performance of the vehicle under these settings is 0.39 g acceleration and the battery 54 consumption is 5.7 kW. In this example, at 12 km/h, the electric motor 18 rotates in the opposite torque direction. In this example, the electric motor 18 brakes the vehicle, regenerates power, and recharges the battery 54.

In another example, at vehicle speed 90 km/h, the software 134 sets torque of the electric motor 18 at 100.2 Nm, the speed of the electric motor 18 at 3810 rpm, the speed of the engine 22 at 4250 rpm, the power delivery of the engine at 40 kW, and the displacement of the hydraulic pump 66 at 0.15 cc. An example of the performance of the vehicle under these settings is 0.15 g acceleration, and the battery 54 consumption is 40 kW.

The example vehicle accelerates from a stop to 180 km/h in about 88.5 s. The battery 54 charge consumption during such acceleration is about 3400 kJ. Note also that at a low vehicle speed, for example at 12 km/h, the battery 54 charge is regenerated by the engine 22 while the vehicle is accelerating.

A maximum stroke of the accelerator pedal 138 typically indicates to the software 134 that the driver desires maximum acceleration. The following example facilitates maximizing acceleration of the vehicle when the software 134 recognizes that the engine 22 is off. The vehicle speed or the vehicle drive axle 30 speed is sometimes used as a second input information to the software 134. In this operating condition, the gear ratio of the CGRVT 56 is relatively infinite since the displacement of the hydraulic pump 66 with variable displacement is −27.78 cc. The first shaft 50 of the planetary gear differential 34 is also locked against rotation and there is a direct gear ratio from the electric motor 18, through the second shaft 14, through the third shaft 32, and to the vehicle drive axle 30. According to the speed of the vehicle, the software 134 will set the speed and torque of the electric motor 18 and will keep the gear ratio of the CGRVT 56 locked against rotation.

In one example of acceleration when the engine 22 is off and the speed of the vehicle is 12 km/h, the software 134 sets the torque of the electric motor 18 at 214.8 Nm, the speed of the electric motor 18 at 1016 rpm, the displacement of the hydraulic pump 66 at −27.78 cc. The performance of the vehicle is 0.39 g acceleration, and the battery 54 consumption is 22.9 kW under these conditions.

In one example acceleration when the engine 22 is off and the speed of the vehicle is 90 km/h, the software 134 sets the torque of the electric motor 18 at 50.1 Nm, the speed of the electric motor 18 at 7621 rpm, the displacement of the hydraulic pump 66 at −27.78 cc. The performance of the vehicle is 0.06 g acceleration, and the battery 54 consumption is 40 kW under these conditions.

In one example, for a full acceleration from rest to a maximum speed of 138 km/h, the vehicle requires 99.7 s, the battery 54 charge consumption is 4000 kJ. Note also that in this example, the charge of the battery 54 is consumed at any vehicle speed.

In an example situation of a constant vehicle speed with the engine 22 on, the software 134 recognizes that the engine 22 is on. A relatively constant position of the accelerator pedal 138 is the primary input information to the software 134 that the driver desires a constant speed. As a second input, the vehicle speed or the speed of the vehicle drive axle 30 can be used properly to set complete system parameters.

Based on the speed of the vehicle (an example type of input signal to the software 134) the software 134 sets the speed and torque of the electric motor 18, the engine 22 maximum speed, the engine 22 torque, and the gear ration of the CGRVT 56.

In one example, at a relatively constant vehicle speed of 24 km/h with the engine 22 on, the software 134 sets the electric motor 18 torque at 9.2 Nm, the electric motor 18 speed at −5589 rpm, the engine 22 speed at 4250 rpm, the engine 22 power delivery at 7.4 kW and the hydraulic pump 66 displacement at 28.08 cc. The charge regenerated for the battery 54 is 5.4 kW in such an example. In this example, at 24 km/h, the electric motor 18 and the second input shaft 14 rotate in the opposite torque direction. Also in this example, the electric motor 18 charges the battery 54 using regenerative braking.

In another example, at relatively constant vehicle speed of 90 km/h, the software sets the electric motor 18 torque at 19.3 N, the electric motor 18 speed at 0 rpm, the engine 22 speed at 4250 rpm, the engine 22 power delivery at 15.4 kW, and the hydraulic pump 66 displacement at 28.08 cc.

In both the 24 km/h and 90 km/h constant speed examples, the power from the engine 22 is not enwheelly routed to the planetary gear differential 34. Some of the engine 22 power available is used to recharge the battery 54 through the electric generator 58.

In the constant speed 24 km/h example, the electric motor 18 is rotating in the opposite torque direction and uses regenerative braking to charge battery 54 while in the 90 km/h example, the engine 22 powers the first shaft 50 to move the vehicle at relatively constant speed. In the 90 km/h example, the second input shaft 14 is locked against rotation, so that no mechanical power is transmitted from or to the engine 22. The power that the engine 22 delivers to the planetary gear differential 34 in this example is primarily used to move the vehicle.

In an example of a constant vehicle speed with the engine 22 off. The primary input information to the software 134 that the driver desires such a condition is the accelerator pedal 138 stroke at the constant speed position. The vehicle speed or the vehicle drive axle 30 speed is also used as a second input information to set properly all the system parameters.

The software 134 sets set the speed and torque of the electric motor 18 according to the vehicle speed (input signal to the software 134). The overall gear ratio of the CGRVT 56 is kept in such a way that the speed at the first shaft 50 of the planetary gear differential 34 will be locked against rotation.

In one example, at vehicle speed 24 km/h, the software 134 sets the electric motor 18 torque at 9.2 Nm, the speed of the electric motor 18 at 2032 rpm, the engine 22 speed at 0 rpm and the displacement of the hydraulic pump 66 at −27.78 cc. The battery 54 charge consumption is about 2.0 kW under these conditions.

In one example, at vehicle speed 90 km/h, the software 134 sets the electric motor 18 torque at 19.3 Nm, the speed of the electric motor 18 at 7621 rpm, the speed of the engine 22 at 0 rpm and the displacement of the hydraulic pump −27.78 cc. The battery 54 charge consumption is about 15.4 kW under these conditions.

In both the 24 km/h and the 90 km/h constant speeds with the engine 22 off, the power consumption from the battery 54 corresponds to the required amount for to overcome rolling resistance on the wheel 38 and friction on the vehicle. Further, the battery 54 is not recharged at constant vehicle speed with the engine 22 off.

In an example of a maximum deceleration with the engine 22 on, releasing the accelerator pedal 138 indicates to the software 134 that the maximum deceleration is desired. The software 134 also recognizes that the engine 22 is on. For this example operating condition, the service or parking brake for the vehicle is not actuated. The vehicle deceleration energy primarily moves to the battery 54. Accordingly, the battery 54 charge is regenerated. The vehicle speed or the drive axle speed 30 provides a secondary input information to the software 134. In such an example, the software 134 sets the electric motor 18 speed and torque, the engine 22 speed and release torque, and the appropriate gear ratio for the CGRVT 56 according to the vehicle speed.

In one example condition during deceleration at vehicle speed 12 km/h with the engine 22 on, the software 134 sets the electric motor 18 torque at −137.5 Nm, the electric motor 18 speed at 1016 rpm, the engine 22 speed at any preferred value (e.g., 1000 rpm), the engine 22 power delivery at 0 kW and the displacement of the hydraulic pump 66 at −27.78 cc. The vehicle performance is −0.28 g deceleration and the battery 54 is recharged with 14.6 kW under these conditions.

In another example operating scenario, during deceleration from a vehicle speed of 24 km/h with the engine 22 on, the software 134 sets the electric motor 18 torque at −137.5 Nm, the electric motor 18 speed at 2032 rpm, the engine 22 speed at any preferred value (e.g., 1000 rpm), the engine 22 power delivery at 0 kW, and the displacement of the hydraulic pump 66 at −27.78 cc. The vehicle performance is −0.28 g deceleration, and the battery 54 is recharged with 29.3 kW under these conditions.

In another example operating scenario, during deceleration from a vehicle speed of 90 km/h with the engine 22 on, the software 134 sets the electric motor 18 torque at −78.3 Nm, the electric motor 18 speed at 7621 rpm, the engine 22 speed at any preferred value (e.g., 1000 rpm), the engine 22 power delivery at 0 kW, and the displacement of the hydraulic pump at −27.78 cc. The vehicle performance is −0.19 g deceleration, and the battery 54 is recharged with 62.5 kW under these conditions.

In another example operating scenario, during deceleration from a vehicle speed of 162 km/h with the engine 22 on, the software 134 sets the electric motor 18 torque at −43.5 Nm, the electric motor 18 speed at 11685 rpm, the engine 22 speed at 4250 rpm, the engine 22 power delivery at −9.3 kW (the engine 22 power delivery is negative because the vehicle is braking and there is no fuel consumption) and the displacement of the hydraulic pump 66 at −12.88 cc. The vehicle performance is −0.17 g deceleration, and the battery 54 is recharged with 53.2 kW under these conditions.

In another example operating scenario, during deceleration from a vehicle speed of 180 km/h with the engine 22 on, the software 134 sets the electric motor 18 torque at −39.2 Nm, the electric motor 18 speed at 11685 rpm, the engine 22 speed at 4250 rpm, the engine 22 power delivery at −14.6 kW (the engine 22 power delivery is negative because the vehicle is braking and there is no fuel consumption), and the displacement of the hydraulic pump 66 at −1.17 cc. The vehicle performance is −0.17 g deceleration, and the battery 54 is recharged with 47.9 kW under these conditions.

In another example operating scenario, during deceleration from 180 km/h with the engine 22 on, the necessary driven torque to keep the engine 22 at maximum speed 4250 rpm with no gas is 32.77 Nm, for example. At 180 km/h, the engine 22 and the electric motor 18 brake the vehicle simultaneously. In this example, during deceleration with the engine 22 on, between 138 km/h and 180 km/h a certain amount of engine 22 brake torque is required to decelerate the vehicle. Within this range of vehicle speeds, the CGRVT 56 overall gear ratio is not infinite and the first shaft 50 of the planetary gear differential 34 is no longer locked. The electric motor 18 brake torque is set according to the engine 22 brake torque and the CGRVT 56 overall gear ratio to avoid speeding the engine 22 to a higher speeds. Between 138 km/h and 180 km/h, the fuel supply to the engine 22 can be further reduced in order to increase the engine 22 brake torque and to minimize the fuel consumption.

In these example decelerations with the engine 22 on, the electric generator 58 that is applied to the engine 22 provides further charge to the battery 54.

In another example operating scenario, during deceleration from a vehicle speed 162 of km/h with the engine 22 on, the brake torque required from the engine 22 to decelerate the vehicle is −20.80 Nm. To avoid the engine 22 speed decreasing from 4250 rpm, the software 134 provides the engine 22 with fuel to maintain the engine 22 speed at about 4250 rpm. The software 134 controls the engine 22 in this operating scenario if the engine 22 speed is one of the input information to the software 134.

In another example operating scenario, during decelerations from vehicle speeds below 138 km/h, say at 90 km/h, with the engine 22 on, the CGRVT 56 overall gear ratio is infinite. In this operating condition, the engine 22 speed drops to the minimum value (for example 1000 rpm) and is then switched off. The engine 22 switches off while the vehicle is still running at a lower speed than 138 km/h because the first shaft 50 of the planetary gear differential 34 is locked against rotation.

In another operating scenario, during deceleration from a vehicle speed of 138 km/h to 0 km/h the kinematic energy of the vehicle recharges the battery 54. A portion of the vehicle kinematic energy does not recharge the battery 54 and is absorbed by the resistance on the wheel 38 and air friction. Note that the electric motor 18 torque curve during deceleration differs sometimes from the curve during acceleration. In this example, decelerating the vehicle to a stop takes 25.4 s and the battery 54 is charged with 1400 kJ.

In an example scenario maximizing deceleration with the engine 22 off, the operator releases the accelerator pedal 138 to indicate to the software 134 the desired maximized deceleration. For this example, the service or parking brake for the vehicle is not actuated. Instead, recharging the battery, the wheel rolling resistance, and the air friction decelerates the vehicle. The engine 22 remains off in this example and the CGRVT 56 overall gear ratio is infinite. The first shaft 50 also remains locked against rotation. The software 134 will set the electric motor torque and speed according to the vehicle speed.

In an example operating scenario during deceleration from a vehicle speed of 24 km/h with the engine 22 off, the software 134 sets the electric motor 18 torque at −137.5 Nm, the electric motor 18 speed at 2032 rpm, the engine 22 speed at 0 rpm, the engine 22 power delivery at 0 kW, and the hydraulic pump 66 displacement at −27.78 cc. The vehicle performances are −0.28 g deceleration and the battery is recharged with 29.3 kW under these conditions.

In another example operating scenario during deceleration from a vehicle speed of 90 km/h with the engine 22 off, the software 134 sets the electric motor 18 torque at −78.3 Nm, the electric motor 18 speed at 7621 rpm, the engine 22 speed at 0 rpm, the engine 22 power delivery at 0 kW, and the displacement of the hydraulic pump 66 at −27.78 cc. The vehicle performances are −0.19 g deceleration and the battery 54 is recharged with 62.5 kW under these conditions.

Note that during deceleration with the engine 22 off, at 24 km/h as well as 90 km/h, the system operating parameters are substantially the same as when the engine 22 was on. The only difference is that the engine 22 is off and is not rotating.

Also, in the two immediately above operating conditions, during deceleration between 138 km/h and 0 km/h, the CGRVT 56 overall gear ratio is infinite, and the first shaft 50 of the planetary gear differential 34 is locked against rotation. The engine 22 can thus be switched off while the vehicle is still running.

In the range of the vehicle speeds from 138 km/h to 0 km/h the dynamic energy of the vehicle recharges the battery 54. In such example, stopping the vehicle from 138 km/h requires about 18.3 s, and the battery 54 is charged with 1000 kJ during the deceleration time.

Under intermediate operating conditions, such as when the accelerator pedal 138 is in an intermediate stroke position, the output parameters of the software 134 can be determined by varying their value according to a mathematical formula. The output parameters of the software 134 will set the complete system properly according to the intermediate position of the accelerator pedal 138.

Although described in terms of a planetary gear differential, other examples may include spherical differential arrangements or any other type of device with the mathematical relationships as described above. Exemplary performance results of the example planetary gear differential 34 are as follows. For simplification purposes, in the following equations, “1” corresponds to the second shaft 14, “2” corresponds to the third shaft 32, and “3” corresponds to the first shaft 50.

In this example, the speed relationships are represented by:

Z1*N1+Z3*N3=(Z1+Z3)*N2.

The example torque relationships are represented by:

T2=T1*(Z1+Z3)/Z1; T3=T2−T1; T3=T1*Z3/Z1.

The planetary gear speed is represented by: N2=(N3ΔN2)*Z3/Z2.

The input power provided to 1 is represented by: P1=2*P1*(N1/60)*T1.

The output power from 2 is represented by: P2=2*P1*(N2/60)*T2.

The input power provided to 3 is represented by: P3=2*P1*(N3/60)*T3.

In the above equations: Z1 equals the number of teeth on the sun gear (Z1=43 in this example), Z2 equals the number of teeth on the planetary gear (Z2=40 in this example), Z3 equals number of teeth on the ring gear (Z3=122 in this example), N1 equals the sun gear speed in rpm, N2 equals the planetary carrier speed in rpm, N3 equals the ring gear speed in rpm, N2 equals planet gear speed (referred to as the planetary carrier pin) in rpm, T1 equals the sun gear torque in Nm, T2 equals the planetary carrier torque in Nm, T3 equals the ring gear torque in Nm, P1 equals the sun gear power in kW, P2 equals the planetary carrier power kW, and P3 equals the ring gear power in kW.

In one example of maximizing vehicle acceleration with the engine 22 using the above example equations produces the following results at a vehicle speed of 12 km/h: N1 rotates at −762 rpm, N2 rotates at 265 rpm, N3 rotates at 626.8 rpm, T1 corresponds to 214.8 Nm of torque, T2 corresponds to 824 Nm of torque, T3 corresponds to 609.4 Nm of torque, P1 corresponds to −17.1 kW of power, P2 corresponds to 22.9 W of power, and P3 corresponds to 40 kW of power. In this example operation condition, the sun gear rotates in a direction opposite the torque direction. The power provided by the electric motor 18 to the planetary gear differential 34 is negative indicating that at least a portion of the engine 22 power (17.1 kW of the total 40 kW) moves to the electric motor 18 to recharge the battery 54.

In another example using the above example equations and maximizing the vehicle acceleration with the engine 22 on produces the following results at a vehicle speed of 24 km/h: N1 rotates at 254 rpm, N2 rotates at 530 rpm, N3 rotates at 626.8 rpm, T1 corresponds to 214.8 Nm of torque, T2 corresponds to 824 Nm of torque, T3 corresponds to 609.4 Nm of torque, P1 corresponds to 5.7 kW of power, P2 corresponds to 45.7 kW of power, P3 corresponds to 40 kW of power. In this example operating condition, the sun gear rotates in the same direction as the torque direction. The power provided by the electric motor 18 to the planetary gear differential 34 is positive, which indicates that, in the planetary gear differential 34, the power coming from the electric motor 18 is added to the power coming from the engine 22 and that the total value provided to the vehicle drive axle 30. The battery 54 consumes 5.7 kW of power in this example.

In another example using the above example equations and maximizing the vehicle acceleration with the engine 22 on produces the following results at a vehicle speed of 90 km/h: N1 rotates at 3810 rpm, N2 rotates at 1986 rpm, N3 rotates at 1343.1 rpm, T1 corresponds to 100.2 Nm of torque, T2 corresponds to 383 Nm of torque, T3 corresponds to 284.4 Nm of torque, P1 corresponds to 40 kW of power, P2 corresponds to 80 kW of power, P3 corresponds to 40 kW of power. In this example operation condition, the sun gear rotates in the same direction as the torque direction, which indicates that, in the planetary gear differential 34, the power coming from motor 18 is added to the power coming from the engine 22, and that the total value is equal to the output power to the vehicle drive axle 30. The battery 54 consumes 40 kW of power in this example.

In another example using the above example equations and maximizing the vehicle acceleration with the engine 22 off produces the following results at a vehicle speed of 12 km/h: N1 rotates at 1016 rpm, N2 rotates at 265 rpm, N3 rotates at 0.0 rpm, T1 corresponds to 214.8 Nm of torque, T2 corresponds to 824 Nm of torque, T3 corresponds to 609.4 Nm of torque, P1 corresponds to 22.9 kW of power, P2 corresponds to 22.9 kW of power, P3 corresponds to 0 kW of power. In this example operation condition, the sun gear rotates in the same direction as the torque direction, which indicates that the engine 22 provides no power. Instead, the electric motor 18 provides the power, through the planetary gear differential 34, to the vehicle drive axle 30. The battery 54 charge is consumed, and the battery 54 provides 22.9 kW of power.

In another example using the above example equations and maximizing the vehicle acceleration with the engine 22 off produces the following results at a vehicle speed of 90 km/h: N1 rotates at 7621 rpm, N2 rotates at 1986 rpm, N3 rotates at 0.0 rpm, T1 corresponds to 50.1 Nm of torque, T2 corresponds to 192 Nm of torque, T3 corresponds to 142.2 Nm of torque, P1 corresponds to 40 kW of power, P2 corresponds to 40 kW of power, P3 corresponds to 0 kW of power. In this example operation condition, the sun gear rotates in the same direction as the torque direction, which indicates that the engine 22 provides no power. Instead, the electric motor 18 provides the power, through the planetary gear differential 34, to the vehicle drive axle 30. The battery 54 charge is consumed, and the battery 54 provides 40 kW of power.

In another example using the above example equations and maintaining the vehicle acceleration with the engine 22 on produces the following results at a vehicle speed of 24 km/h: N1 rotates at −5589 rpm, N2 rotates at 530 rpm, N3 rotates at 2686.2 rpm, T1 corresponds to 9.2 Nm of torque, T2 corresponds to 35 Nm of torque, T3 corresponds to 26.2 Nm of torque, P1 corresponds to 5.4 kW of power, P2 corresponds to 2.0 kW of power, P3 corresponds to 7.4 kW of power. In this example operation condition, the sun gear rotates in the opposite direction (negative speed) from the torque direction, which means that the power provided by the electric motor 18 to the planetary gear differential 34 is negative. Thus part of the engine 22 power (5.4 kW of the total 7.4 kW in this example) moves to the electric motor 18 through the planetary gear differential 34 to recharge the battery 54.

In another example using the above example equations and maintaining the vehicle acceleration with the engine 22 on produces the following results at a vehicle speed of 90 km/h: N1 rotates at 0 rpm, N2 rotates at 1986 rpm, N3 rotates at 2686.1 rpm, T1 corresponds to 19.3 Nm of torque, T2 corresponds to 94 Nm of torque, T3 corresponds to 54.8 Nm of torque, P1 corresponds to 0 kW of power, P2 corresponds to 15.4 kW of power, P3 corresponds to 15.4 kW of power. In this example operating condition, the sun gear does not rotate, which means that no power is transmitted from or to the electric motor 18. Instead, the power from the engine 22 moves through the planetary gear differential 34 to the vehicle drive axle 30. There is no battery 54 charge consumption in this example.

In another example using the above example equations and maintaining the vehicle acceleration with the engine 22 off produces the following results at a vehicle speed of 24 km/h: N1 rotates at 2032 rpm, N2 rotates at 530 rpm, N3 rotates at 0.0 rpm, T1 corresponds to 9.2 Nm of torque, T2 corresponds to 35 Nm of torque, T3 corresponds to 26.2 Nm of torque, P1 corresponds to 2.0 kW of power, P2 corresponds to 2.0 kW of power, P3 corresponds to 0 W. In this example operation condition, the sun gear rotates in the same direction as the torque direction and the engine 22 provides no power, which means that the power from the electric motor 18 moves through the planetary gear differential 34 to the vehicle drive axle 30 and that some battery 54 charge is consumed. The battery 54 provides 2.0 kW of power in this example.

In another example using the above example equations and maintaining the vehicle acceleration with the engine 22 off produces the following results at a vehicle speed of 90 km/h: N1 rotates at 7621 rpm, N2 rotates at 1986 rpm, N3 rotates at 0.0 rpm, T1 corresponds to 19.3 Nm of torque, T2 corresponds to 74 Nm of torque, T3 corresponds to 54.8 Nm of torque, P1 corresponds to 15.4 kW of power, P2 corresponds to 15.4 kW of power, P3 corresponds to 0 W. In this example operation condition, the sun gear rotates in the same direction as the torque direction and the engine 22 provides no power, which means that the power from the electric motor 18 moves through the planetary gear differential 34 to the vehicle drive axle 30 and that some battery 54 charge is consumed. The battery 54 provides 15.4 kW of power in this example.

In another example using the above example equations and maximizing the vehicle deceleration with the engine 22 on produces the following results at a vehicle speed of 12 km/h: N1 rotates at 1016 rpm, N2 rotates at 265 rpm, N3 rotates at 0.0 rpm, T1 corresponds to −137.5 Nm of torque, T2 corresponds to −528 Nm of torque, T3 corresponds to −390 Nm of torque, P1 corresponds to −14.6 kW of power, P2 corresponds to −14.6 W, P3 corresponds to 0 W. In this example operation condition, the sun gear torque is an opposite direction from the sun gears rotational direction and the power P1 is negative, which means that the power from the vehicle drive axle 30 moves through the planetary gear differential 34 to the electric motor 18 and recharges the battery 54. The battery provides 14.6 kW of power in this example.

In another example using the above example equations and maximizing the vehicle deceleration with the engine 22 on produces the following results at a vehicle speed of 24 km/h: N1 rotates at 2032 rpm, N2 rotates at 350 rpm, N3 rotates at 0.0 rpm, T1 corresponds to −137.5 Nm of torque, T2 corresponds to −528 Nm of torque, T3 corresponds to −390.1 Nm of torque, P1 corresponds to −23.9 kW of power, P2 corresponds to −29.3 W, P3 corresponds to 0 W. In this example operating condition, the sun gear torque is in opposite its rotational direction and the power P1 is negative, which means that the power moves from the vehicle drive axle 30 through the planetary gear differential 34 to the electric motor 18 to recharge the battery 54. The deceleration provides 29.3 kW of power in this example.

In another example using the above example equations and maximizing the vehicle deceleration with the engine 22 on produces the following results at a vehicle speed of 90 km/h: N1 rotates at −7621 rpm, N2 rotates at 1986 rpm, N3 rotates at 0.0 rpm, T1 corresponds to −78.3 Nm of torque, T2 corresponds to −301 Nm of torque, T3 corresponds to −222.2 Nm of torque, P1 corresponds to −62.5 kW of power, P2 corresponds to −62.5 W, P3 corresponds to 0 W. In this example operating condition, the sun gear torque is in opposite direction the sun gear rotational direction and the power P1 is negative, which means that all the power moves from the vehicle drive axle 30 through the planetary gear differential 34 to the electric motor 18 to recharge the battery 54. The deceleration provides 62.5 kW of power in this example.

In another example using the above example equations and maximizing the vehicle deceleration with the engine 22 off produces the following results at a vehicle speed of 24 km/h: N1 rotates at 2032 rpm, N2 rotates at 530 rpm, N3 rotates at 0.0 rpm, T1 corresponds to −137.5 Nm of torque, T2 corresponds to −528 Nm of torque, T3 corresponds to −390.1 Nm of torque, P1 corresponds to −29.3 kW of power, P2 corresponds to −29.3 kW of power, P3 corresponds to 0 kW of power. In this example operating condition, the sun gear torque is opposite the rotation direction of the sun gear and the power P1 is negative, which means that the power moves from the vehicle drive axle 30 through the planetary gear differential 34 to the electric motor 18 and recharges the battery 54. The deceleration provides 29.3 kW of power in this example.

In another example using the above example equations and maximizing the vehicle deceleration with the engine 22 off produces the following results at a vehicle speed of 90 km/h: N1 rotates at −7621 rpm, N2 rotates at 1986 rpm, N3 rotates at 0.0 rpm, T1 corresponds to −78.3 Nm of torque, T2 corresponds to −301 Nm of torque, T3 corresponds to −222.2 Nm of torque, P1 corresponds to −62.5 kW of power, P2 corresponds to −62.5 W, P3 corresponds to 0 W. In this example operating condition, the sun gear torque is opposite the rotational direction of the sun gear and the power P1 is negative, which means that the power moves from the vehicle drive axle 30 through the planetary gear differential 34 to the electric motor 18 and recharges the battery 54. The deceleration provides 62.5 kW of power in this example.

Although a preferred embodiment has been disclosed, a worker of ordinary skill in this art would recognize that certain modifications would come within the scope of this invention. For that reason, the following claims should be studied to determine the true scope and content of this invention.

We claim:

1. A vehicle propulsion arrangement comprising:
a planetary gear differential;
a first branch of the planetary gear differential rotatably connected to a first source of rotation;
a second branch of the planetary gear differential rotatably connected to a second source of rotation;
a third branch of the planetary gear differential rotatably connected to a vehicle drive axle, wherein the first branch, the second branch, or both, rotate the third branch of the planetary gear system to rotate the vehicle drive axle.

2. The arrangement of claim 1, wherein the first source of rotation and the second source of rotation rotate the third branch together in parallel.

3. The arrangement of claim 1, wherein the second source of rotation comprises a reversible machine operative to rotatably drive the second branch of the planetary gear differential or to receive a rotational input from the second branch of the planetary gear differential.

4. The arrangement of claim 3, wherein the reversible machine comprises at least one of an AC electric motor, a DC electric motor or an air compressor.

5. The arrangement of claim 3, including an accumulator that is operative to power to the reversible machine to rotatably drive the second branch of the planetary gear differential or to receive power from the reversible machine.

6. The arrangement of claim 5, wherein the accumulator comprises at least one of a rechargeable battery or tank of compressed gas.

7. The arrangement of claim 1, wherein the first source of rotation comprises a gas engine operative to rotatably drive the first branch of the planetary gear differential.

8. The arrangement of claim 7, wherein the gas engine is operative to rotate the second branch of the planetary gear differential by rotatably driving the first branch of the planetary gear differential and to recharge an accumulator through a reversible machine rotatably connected to the second branch of the planetary gear differential.

9. The arrangement of claim 7, including a continuous gear ratio variation transmission that communicates rotation of a shaft of the gas engine to the first branch of the planetary gear differential.

10. The arrangement of claim 9, wherein the continuous gear ratio variation transmission comprises at least one of a hydraulic device, a mechanical device, and an electrical device.

11. The arrangement of claim 9, wherein the continuous gear ratio variation transmission comprises a gear reduction unit connected in a series or parallel configuration.

12. The arrangement of claim 9, wherein the continuous gear ratio variation transmission receives a rotational input from the shaft of the gas engine at a first rotational speed and is operative to rotate the first branch of the planetary gear differential at a second rotational speed, the first rotational speed different from the second rotational speed.

13. The arrangement of claim 12, wherein the second rotational speed is zero and the first rotational speed is not zero in at least one operating condition.

14. The arrangement of claim 9, including a controller that controls at least one of the gas engine, the gear ratio of the continuous gear ratio variation transmission, and an reversible machine, wherein the second source of rotation comprises the rotational machine.

15. The arrangement of claim 3, including an inverter operative to control a speed and a torque of the reversible machine,

16. The arrangement of claim 5, including an inverter operative to communicate power to the reversible machine from the accumulator when the reversible machine is rotating in a first direction and generating torque in the first direction, or to supply power from the reversible machine to the accumulator when the reversible machine is rotating a second direction opposite the first direction.

17. The arrangement of claim 5, including a generator connected to a gas engine operative to recharge the accumulator, wherein the first source of rotation comprises the gas engine.

18. The arrangement of claim 14, including a mechanical device moveable to positions that communicates a desired acceleration, constant speed, or deceleration to the controller.

19. The arrangement of claim 18, wherein the mechanical device is an accelerator pedal.

20. The arrangement of claim 1, wherein the rotational speed of the first branch of the planetary gear differential, the rotational speed of second branch of the planetary gear differential, or both, controls the rotational speed of the third branch of the planetary gear differential.

21. The arrangement of claim 1, wherein power transmitted from and to the planetary gear differential is proportional to each of the rotational speed of the first branch, the rotational speed of the second branch, and the rotational speed of the third branch.

22. A system for propelling a vehicle comprising:
a planetary gear arrangement;
a hydraulic drive assembly operative to rotatably drive a first shaft of the planetary gear arrangement;
an engine powering the hydraulic drive assembly and including an engine shaft operative to rotatably drive the hydraulic drive assembly, the input shaft rotatable at a different speed than the first shaft;
an electric motor operative to rotatably drive a second shaft of the planetary gear arrangement;
a rechargeable battery powering the electric motor; and
a third shaft of the planetary gear arrangement operative to rotatably drive a vehicle drive axle.

23. The system of claim 22, including a controller configured to select rotating the shaft using the electric motor or the hydraulic drive assembly, wherein rotating the shaft optionally charges the rechargeable battery.

24. The system of claim 22, wherein the controller is in communication with an accelerator pedal of the vehicle, the controller selects based on the position of the accelerator.

25. The system of claim 22, wherein the hydraulic drive assembly comprises a continously variable transmission assembly.

26. The system of claim 22, including a generator adapted to power the engine.

27. The system of claim 22, wherein the engine is at least one of a gas turbine engine, a diesel engine, and an internal combustion engine.

28. A method of propelling a vehicle comprising the steps of:
a) powering a hydraulic drive assembly with an engine shaft rotating at a first speed;
b) rotating a first shaft at a second speed with the hydraulic drive assembly, the first shaft rotatably connected to a planetary gear arrangement;
c) rotating a second shaft with an electric motor, the second shaft rotatably connected to a planetary gear arrangement;
d) rotating a third shaft to rotate a vehicle drive axle using the first shaft, the second shaft or both.

29. The method of claim 28, wherein the first speed is different than the second speed.

30. The method of claim 28, including powering the electric motor with a battery.

31. The method of claim 28, including rotating the second shaft with the first shaft, the third shaft, or both, to recharge the battery.

32. The method of claim 28, wherein the engine is selectively rotatably linked to the shaft.
